(19) United States
(12) Patent Application Publication
(10) Pub. No.: US 2005/0098613 A1
(43) Pub. Date: May 12, 2005

(54) Method for diffusion bond welding for use in a multilayer electronic assembly

(76) Inventor: William W. Barker, East Syracuse, NY (US)

Correspondence Address: BOND, SCHOENECK & KING, PLLC, ONE LINCOLN CENTER, SYRACUSE, NY, 13202-1355, US

(21) Appl. No.: 10/704,029

(22) Filed: Nov. 7, 2003

(51) Int. Cl. B23K 35/12

(52) U.S. Cl. 228/193; 228/254

(57) ABSTRACT

The present invention provides a method for forming thermal, mechanical and electrical connections between circuit traces in different layers of a multilayer electronic assembly. The method includes the steps of providing circuit layers with circuit traces of appropriately chosen metal, aligning the layers to form a lay up and exposing the lay up to selected conditions of temperature and pressure, over a period of time, sufficient to fuse the circuit layers to each other and to diffusion bond weld the circuit traces to each other. The present invention also provides a multilayer electronic assembly having circuit trace bonds formed according to the method of the present invention.

### FIELD OF THE INVENTION

The present invention relates to a method for forming thermal, mechanical and electrical connections between circuit traces in different layers of a multilayer electronic assembly, such as an electronic component or a printed circuit board, wherein the circuit traces are welded together under temperature and pressure conditions that will not harm the integrity of the assembly's dielectric layers. The present invention further relates to a multilayer electronic assembly comprising a bond formed according the method of this invention.

### BACKGROUND

Printed circuit boards (PCBs) and certain electronic components are comprised of multiple layers, including metallic ground, signal and power layers, all of which are isolated from each other by interposed layers of dielectric material. It is necessary to provide connections between the layers, for example to connect traces on a first signal layer with traces on another signal layer. It is also necessary in some cases to provide a thermally conductive connection between heat-generating electronic components and a heat sink that may be located at a different location and/or layer on a printed circuit board. It is also necessary in some cases to provide an electrical or mechanical connection with a metal layer that serves to stabilize or stiffen a multilayer electronic assembly.

One method of forming such connections is to form vias that connect ground, signal, power or heat sink traces on one level of the circuit with ground, signal, power or heat sink traces on another level of the circuit. Vias are formed by drilling a hole from one of the desired layers, through the interposing dielectric and other layers, to the other desired layer, and then plating the interior of the hole to provide an electrical connection between the two desired layers. If at least one of the desired layers, however, is not on an exterior surface of the multilayer assembly, a blind via must be formed as the layers of the multilayer assembly are built up. This adds additional steps, for example drilling and plating, to the manufacturing process.

To avoid the additional step of forming vias during build up it is more efficient to form a connection between desired layers in a way that eliminates the need to drill and plate each blind via. One way to do this is to form a hole in the dielectric that will be interposed between the circuit traces that are to be connected and fill the hole with solder. When the printed circuit board is exposed to heat to bond the different layers to each other, the solder will melt and form a connection between the desired circuit traces. Solder, however, typically has a melting point that is below the temperatures to which the multilayer assembly will be exposed during further processing and manufacture. Subsequent steps that require exposure to temperatures higher than the melting point of the solder (for example attaching a chip to a PCB through use of a controlled collapse chip connection) will cause the solder to reflow. Solder reflow is difficult to control and may result in splatter, which can cause short circuits that will make the multilayer assembly unusable.

Two methods have been proposed to avoid the difficulties posed by solder connections. U.S. Pat. No. 5,280,414 to Davis, et al. discloses a method of bonding circuit traces on different layers of a multilayer assembly in which a gold-tin transient liquid bond is formed. The gold and tin are each deposited on the surfaces of two different metallic circuit traces, at the point where the two circuit traces must be connected. After the layers are positioned, they are heated to a temperature that causes the dielectric layers to fuse to each other. Simultaneous with the fusing of the dielectric layers, the gold and tin surfaces form a eutectic bond such that the two different metallic traces are connected to each other electrically, mechanically and thermally. Eutectic bonding, however, requires plating or coating the surfaces to be bonded together with specially selected materials that will form a eutectic bond. The materials plated or coated on the two surfaces cannot be the same material, for example. In addition, because the eutectic or transient liquid bond requires at least one of the bonding metals to melt, at least one of the metals selected must have a melting point below the selected bonding temperature of the assembly.

U.S. Pat. Nos. 4,810,672 and 5,893,511, both to Schwarzbauer, disclose methods of bonding an electronic component to a substrate using sintering. According to these methods, a layer of sinterable powder or paste is deposited on at least one of the two surfaces to be bonded. The two surfaces are then placed in contact with each other and exposed to heat and pressure sufficient to sinter the powder or paste layer, thereby forming a thermal, electrical and mechanical bond between the two surfaces. To achieve the best results, these methods require additional steps such as post-sintering tempering of the bond or equipment intensive precipitation of the powder on the bonding surface. Furthermore, these methods disclose that the bonding surfaces be plated with silver or gold, in addition to use of a sinterable powder or paste.

What is needed is a method of bonding two metal surfaces in the interior of a multilayer electronic assembly that will allow the assembly to be reheated for further manufacturing operations without affecting the integrity of the bond.

What is further needed is a method of bonding two metal surfaces in the interior or exterior of a multilayer electronic assembly wherein the bond has good thermal and electrical conductance.

What is further needed is a method of bonding two metal surfaces in the interior of a multilayer electronic assembly that can be conducted simultaneously with the assembly and bonding of the dielectric layers of a multilayer electronic assembly.

What is finally needed is a method of bonding two metal surfaces in the interior of a multilayer electronic assembly that does not require application of a paste or powder bonding agent prior to forming the bond and also does not require post-bond curing or tempering.

### SUMMARY

These and other objectives are achieved in the present invention, which is directed to a method of bonding two metallic surfaces at the interior of a multilayer electronic assembly. According to the present invention, the two metallic surfaces are bonded by application of temperature and pressure over a period of time sufficient to create a diffusion bond between the surfaces, simultaneously with the process of bonding the dielectric layers of the multilayer electronic assembly to each other. The diffusion bond does not require application of dissimilar metal films, paste or powder and produces a bond that is electrically, thermally and mechanically superior to bonds that use electrically- and thermally-conductive adhesives.

### BRIEF DESCRIPTION OF THE DRAWINGS

The present invention will be more fully understood and appreciated by reading the following Detailed Description in conjunction with the accompanying drawings, in which:

FIG. 1 is a exploded side view of a portion of an electronic assembly containing a bond according to the present invention.

FIG. 2 is a side view of a portion of an electronic assembly containing a bond according to the present invention.

FIG. 3 is a side view of a portion of an electronic assembly containing a bond according to another embodiment of the present invention.

### DETAILED DESCRIPTION

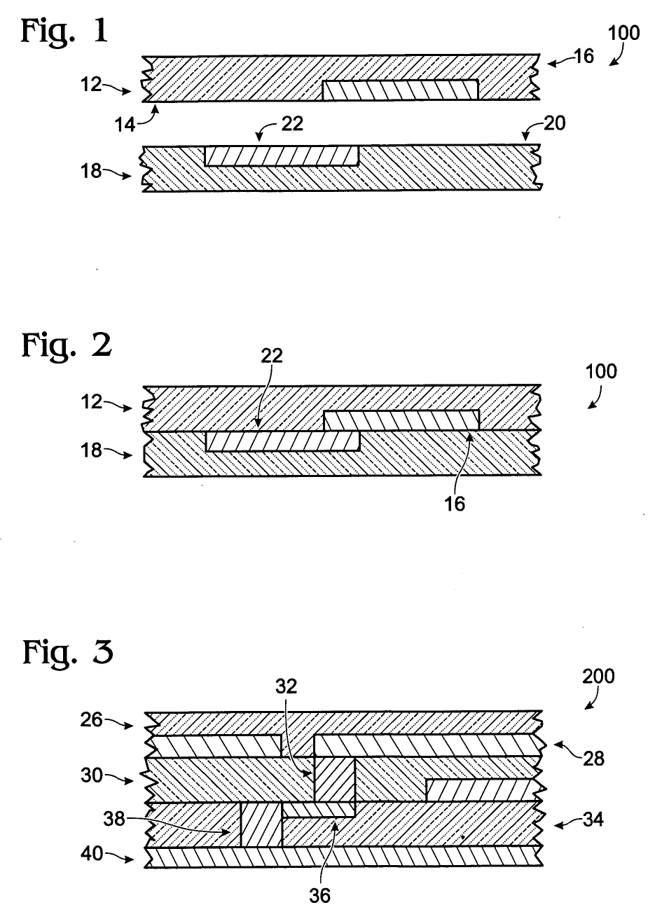

Referring now to FIG. 1, there is seen an exploded side view of a portion of a multilayer electronic assembly 100 containing a bond according to the present invention. The assembly 100 comprises a first dielectric layer 12 having a lower surface 14 on which is formed a first circuit trace 16. The assembly 100 further comprises a second dielectric layer 18 having an upper surface 20 on which is formed a second circuit trace 22. While FIG. 1 depicts an assembly 100 having two layers, this is for ease of display only; the method of the present invention can be used for assemblies 100 having two or more layers. Furthermore, “circuit trace” as used in this application means any conductive metal surface, including a metal stabilization layer, a heat sink layer or a non-conductive component on which a metal layer has been applied, for example, a ceramic object with a metallic surface coating.

According to the method of the present invention, individual layers of the multilayer electronic assembly 100 are first prepared, as is known in the art. Each layer generally comprises a dielectric substrate, such as ceramic, FR4 or polytetrafluoroethylene (PTFE), having two surfaces on which one or more circuit traces may be formed. The circuit traces are formed according to techniques known in the art and are formed of a variety of electrically conductive materials, including copper, silver, gold, phosbronze and other metals.

The materials that will be bonded according to the present invention must be selected based on their ability to form a diffusion bond weld at the temperatures used in forming the multilayer circuit assembly. In the preferred embodiment, the dielectric substrate layers of the multilayer circuit assembly comprise PTFE, which forms a direct bond at temperatures between 680 degrees F. and 720 degrees F., preferably approximately 700 degrees F. Generally, a material can be suitably diffusion bond welded at a temperature that is between 50% and 70% of the material's melting point in degrees K. Thus, preferred bonding materials for an assembly comprising PTFE substrates would be materials with a melting point between approximately 1200 degrees F. and 1850 degrees F., such as silver, aluminum or phosbronze. Furthermore, a diffusion bond weld according to the present invention can be formed between two different metals, provided that at least one of the metals has a melting point that is suitable for the given bonding temperature. For example, at PTFE fusion temperatures—approximately 700 degrees F.—diffusion bonding can take place between copper and silver, even though the melting point of copper is outside of the preferred range.

If the multilayer electronic assembly is constructed using substrates other than PTFE, for example ceramic or FR4, the range of acceptable metals will change with the temperature used to fuse the substrates. In that case, acceptable metals would be determined by determining those metals that have a melting point that is 40% to 100% higher than the highest temperature (in degrees K.) at which the dielectric substrates can be fused.

If the circuit traces to be diffusion bond welded are not formed of metals that are acceptable given the fusion temperature of the substrate, one or both of the surfaces to be diffusion bond welded must be coated with an acceptable metal. For example, if portions of two copper circuit traces are to be diffusion bond welded together in a multilayer PTFE assembly, at least one of the portions to be welded must be coated with a metal such as silver. Coating can be achieved using techniques that are well known in the art, such as electroplating. Generally, a coating of 100 to 200 μinches is preferred. Coatings of less than 100 μinches will form a diffusion bond, but it may not have sufficient mechanical strength for all applications. Coatings of more than 200 μinches will also form a diffusion bond, but the additional material is not necessary for a satisfactory bond.

The individual layers of the assembly 100 require no special preparation other than those steps known in the art for assembling multilayer electronic assemblies.

After the individual layers of the assembly 100 are prepared, they are then aligned with each other and stacked to form a lay up. The lay up is then placed in a vacuum lamination press as is known in the art and exposed to temperature and pressure for a sufficient period of time to bond the individual layers of dielectric together and to form diffusion bonds between adjacent metal surfaces, where required.

The temperature will vary with the material selected for the dielectric substrate and the circuit trace material that must be bonded. For example, if the dielectric material is PTFE and the metal surfaces to be bonded comprise copper and silver-coated copper, the lay up must be heated to a temperature between 680 degrees F. and 720 degrees F., preferably approximately 700 degrees F. Multilayer electronic assemblies that comprise ceramic or FR4 dielectric layers will be processed at different temperatures depending on the temperature typically required to fuse those dielectric substrates to each other. Higher temperatures may accelerate the process of diffusion bonding, but they will also degrade the dielectric and produce an unacceptable product. Lower temperatures will not produce a satisfactory diffusion bond and will also not be sufficient to cause adjacent layers of dielectric to fuse to each other.

The duration of the lamination step, as well as the pressure applied during the lamination step, can vary considerably. Acceptable diffusion bonds have been achieved at lamination durations of as little as 20 minutes. Acceptable diffusion bonds have been achieved at lamination pressures between 450 psi and 1200 psi. The relationship between lamination duration and lamination pressure is roughly inversely proportional. That is, shorter durations will require higher lamination pressure to provide acceptable diffusion bonds. Best results have been achieved when lamination lasts between 60 and 120 minutes, preferably 90 minutes and when the pressure applied is approximately 900 psi.

At the end of the lamination process, adjacent dielectric layers will have fused to each other and adjacent metal surfaces will have diffusion bonded to each other. The lay up can then be cooled to room temperature. No additional tempering or curing is necessary to form a satisfactory diffusion bond weld.

Referring now to FIG. 2, there is a side view of a portion of a multilayer electronic assembly 100 containing a bond according to the present invention. A portion of first circuit trace 16 and a portion of second circuit trace 22 are bonded together, as are portions of first dielectric layer 12 and second dielectric layer 18.

Referring now to FIG. 3, there is a side view of a portion of a multilayer electronic assembly 200 containing multiple bonds according to another embodiment of the present invention. The assembly 200 comprises a first dielectric layer 26 on which is formed a first circuit trace 28. The assembly 200 further comprises a second dielectric layer 30 in which is formed a first via 32. The assembly 200 further comprises a third dielectric layer 34 on which is formed a second circuit trace 36, which is in electrical communication with a second via 38, and a heat sink layer 40. According to this embodiment of the invention, first circuit trace 28 is diffusion bonded to first via 32. First via 32 is diffusion bonded to second circuit trace 36. Second via 38 is diffusion bonded to heat sink layer 40.

While there has been illustrated and described what is at present considered to be the preferred embodiment of the invention, it should be appreciated that changes and modifications are likely to occur to those skilled in the art. It is intended in the appended claims to cover all those changes and modifications that fall within the spirit and scope of the present invention.

1. A method for forming a multilayer electronic circuit assembly comprising the steps of:
providing a first layer comprising a first circuit trace;
providing a second layer comprising a second circuit trace;
positioning said first and second layers to form a lay up wherein said first circuit trace and said second circuit trace are in at least partial contact;
heating said lay up; and
applying pressure to said lay up.

2. The method of claim 1 wherein at least one of said first circuit trace and said second circuit trace comprise metal from the group consisting of silver, aluminum and phosbronze.

3. The method of claim 1 wherein the step of heating said lay up comprises heating said lay up to a temperature between approximately 680 degrees F. and approximately 720 degrees F.

4. The method of claim 1 wherein the step of heating said lay up comprises heating for at least 20 minutes.

5. The method of claim 1 wherein the step of applying pressure to said lay up comprises applying pressure of between approximately 450 psi and approximately 1200 psi.

6. The method of claim 1 wherein the step of applying pressure to said lay up comprises applying pressure of approximately 900 psi.

7. The method of claim 1 wherein the step of applying pressure to said lay up comprises applying pressure of approximately 900 psi for approximately 90 minutes and the step of heating said lay up comprises heating said lay up to a temperature between approximately 680 degrees F. and approximately 720 degrees F. for approximately 90 minutes.

8. A multilayer electronic circuit assembly comprising:
a first layer, further comprising a first circuit trace;
a second layer, further comprising a second circuit trace; and
a diffusion weld between at least a portion of said first circuit trace and at least a portion of said second circuit trace.

9. The assembly of claim 8, wherein at least one of said first circuit trace and said second circuit trace comprises metal from the group consisting of silver, aluminum and phosbronze.

10. The assembly of claim 8, wherein said first layer is a heat sink.

11. The assembly of claim 8, wherein said first layer is a stabilization layer.
